(19) United States
(12) Patent Application Publication
(10) Pub. No.: US 2016/0292163 A1
(43) Pub. Date: Oct. 6, 2016

(54) PROACTIVE IDENTIFICATION OF CONTENT ITEMS FOR A MEMBER OF A SOCIAL NETWORK

(71) Applicant: Linkedln Corporation, Mountain View, CA (US)

(72) Inventors: Qi He, San Jose, CA (US); Bee-Chung Chen, San Jose, CA (US); Joshua Daniel Hartman, Mountain View, CA (US); Zhenhao Hua, Sunnyvale, CA (US); Hsiao-Ping Tseng, Fremont, CA (US)

(21) Appl. No.: 15/076,357

(22) Filed: Mar. 21, 2016

Related U.S. Application Data
(60) Provisional application No. 62/140,489, filed on Mar. 31, 2015.

(51) Int. Cl. G06F 17/30

(52) U.S. Cl. CPC G06F 17/3053; G06F 17/30528; G06F 17/30867; G06F 17/30554

(57) ABSTRACT

A system and method for behavior influenced search ranking may include obtaining, via a network interface, a search term from a user device. An initial result including a first group of the user profiles may be generated based on user profiles from a social network in relation to the search term, the user profiles stored in a profile database. A rank of each of the first group of the user profiles may be determined based, at least in part, on interactions from an activity database corresponding to the first group of the user profiles, the activity database storing information indicative of activities related to the social network, the activities including the interactions. The user device may display a second group of the user profiles, including at least some of the first group of the user profiles, according to the rank of the first group of the user profiles.

### RELATED APPLICATIONS

This application claims the benefit of priority to U.S. Provisional Patent Application Ser. No. 62/140,489, filed Mar. 31, 2015, which is incorporated herein by reference in its entirety.

### TECHNICAL FIELD

The subject matter disclosed herein generally relates to proactively identifying content items for a member of a social network.

### BACKGROUND

Social networks may present content to members of the social network according to a variety of mechanisms. In one mechanism, when a user goes online with the social network, the social network systems may compare the member's history against characteristics of various content items that are stored on the social network. Based on the comparison, certain content items are selected by the social network system and displayed on a user interface of the member.

### BRIEF DESCRIPTION OF THE DRAWINGS

Some embodiments are illustrated by way of example and not limitation in the figures of the accompanying drawings.

FIG. 1 is a block diagram illustrating various components or functional modules of a social network, in an example embodiment.

FIG. 2 is an abstract depiction of a news feed as displayed on a user interface, as generated by the user interface module, in an example embodiment.

FIG. 3 is an abstract block depiction of a content item record that corresponds to one of the content items, in an example embodiment.

FIG. 4 is a block diagram of a content item as displayed in a portion of the news feed and as based on an associated content item record, in an example embodiment.

FIG. 5 is a simplified illustration of a social graph, in an example embodiment.

FIG. 6 is a system for proactively identifying content items for a member of a social network, in an example embodiment.

FIG. 7 is a flowchart for proactively identifying content items for a member of a social network, in an example embodiment.

FIG. 8 is a flowchart for proactively identifying content items for a member of a social network, in an example embodiment.

FIG. 9 is a block diagram illustrating components of a machine able to read instructions from a machine-readable medium.

### DETAILED DESCRIPTION

Example methods and systems are directed to proactively identifying content items for a member of a social network. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Such mechanisms for displaying social network content items to a member may rely on focused criteria for obtaining content items for display to the member. For instance, one mechanism may identify job postings that the member may be qualified for or may be interested in viewing while another mechanism may identify other members or entities (such as groups, companies, and the like) that the member may want to follow on the social network, and so forth. By keeping their scope relatively focused, such mechanisms may efficiently provide content items quickly upon the member logging on to the social network.

However, such mechanisms may be of comparatively limited scope, and if a content item doesn't fall into one of the categories covered by a specific mechanism then the content item may be unlikely to be presented to a member even if the content item is pertinent to that member. But to attempt to assess all or most of the content items of the social network for a given member based on a broad cross-section of characteristics of the content items against social network data of the member may be computationally infeasible or, at minimum, computationally inefficient during a login procedure for the member. Even if such computations could be made possible through sufficient computing resources in an acceptable timeframe so that the member doesn't spend undue or undesirable amounts of time waiting for the social network page to load, the cost in computational resources may be substantial or unnecessary.

A social network system has been developed that provides for the offline identification of a candidate set of content items of the social network that may ultimately be presented to a given member upon logging on to the social network. By identifying a subset of content items of the social network that may be of interest to a member before that member logs in to the social network, the computations may be spread out over minutes, hours, days, or more, rather than within seconds or less at login. The social network system utilizes the social graph of members of the social network to identify the candidate set, which may be a relatively non-intensive computation. The content items of the candidate set may then be individually assessed for relevance to the member or desirability to be displayed to the member. Because candidate set may be significantly smaller than the total population of content items, and/or because the assessments may be performed either upon or prior to member login, more assessment mechanisms may be utilized to identify content items for the member in a way that may burden the system less than attempting to perform the same or similar computations upon login.

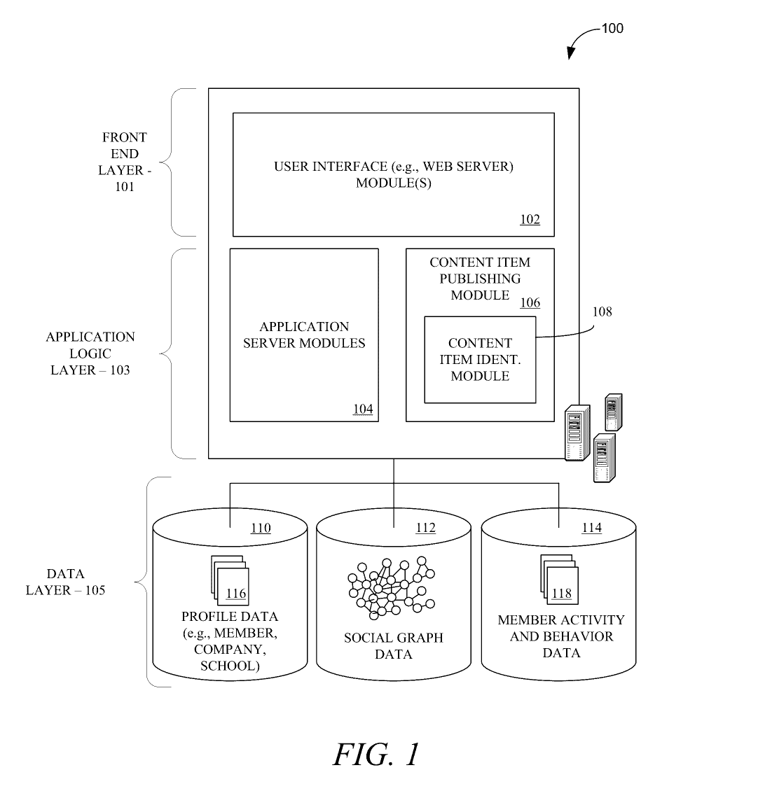

FIG. 1 is a block diagram illustrating various components or functional modules of a social network 100, consistent with some examples. A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104. In some examples, the social network 100 includes a content item publishing module 106, such as may be utilized to receive content, such as electronic messages, posts, links, images, videos, and the like, and publish the content to the social network.

One or more of the application server modules 104, the content item publishing module 106, or the social network 100 generally may include a content item identifier module 108. As will be disclosed in detail herein, the content item identifier module 108 may identify a candidate set of content items for a given member and then individually assess those content items of the candidate set for relevance to the member. The content item identifier module 108 may obtain social graph information, among other potential data, to generate the candidate set and may then use profile and activity data to determine the relevance, among other potential data. The content item identifier module 108 may generate the candidate set in an offline mode and then determine the relevance in either an offline or an online mode. It is to be understood that while the content item identifier module 108 is described as an integral component of a social network, the principles described herein may be applied without the content item identifier module 108 being an integral part of a social network.

As illustrated, the data layer 105 includes, but is not necessarily limited to, several databases 110, 112, 114, such as a database 110 for storing profile data 116, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

Activities by users of the social network 100, including past searches that have been conducted by the search module 108, may be logged as activities 118 in the activity and behavior database 114. Such activities may include search terms, interactions with search results and subsequent engagement with the subject of search results, scores assigned to such search terms, as disclosed herein, communication with others via the social network, engagement with content items posted on the social network, joining groups, following entities, and so forth.

The social network service may provide a broad range of other applications and services that allow members the opportunity to share and receive information, often customized to the interests of the member. For example, with some examples, the social network service may include a photo sharing application that allows members to upload and share photos with other members. With some examples, members may be able to self-organize into groups, or interest groups, organized around a subject matter or topic of interest. With some examples, the social network service may host various job listings providing details of job openings with various organizations.

Although not shown, with some examples, the social network 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

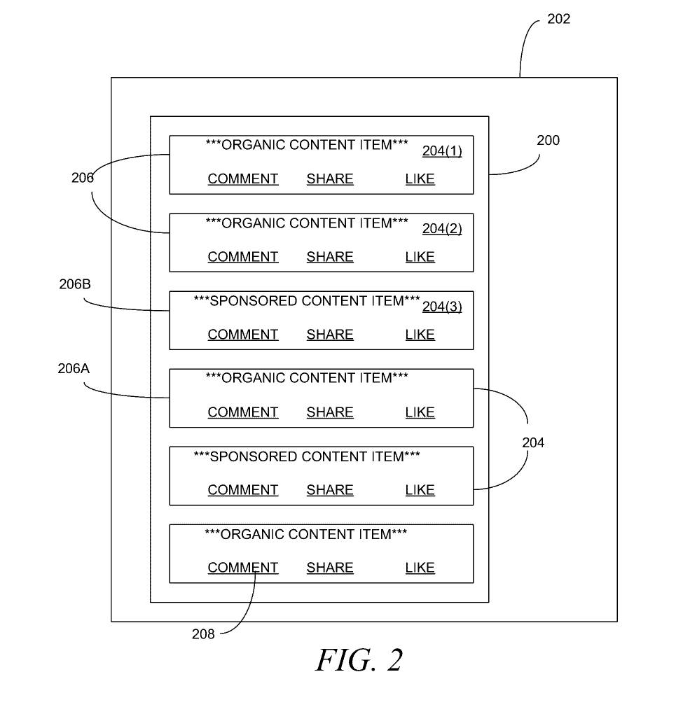

FIG. 2 is an abstract depiction of a news feed 200 as displayed on a user interface 202, as generated by the user interface module 102, in an example embodiment. The news feed 200 includes multiple positions 204 in which individual content items 206 are displayed. While the positions 204 are illustrated as a top-down list, it is to be understood that the positions 204 may be any of a variety of ordered or orderable positions 204, such as tiles or a ribbon bar. The content items 206 are variously organic content items 206A generated based on content provided to the social network by members of the social network and sponsored content items 206B generated based on a fee paid to the administrators of the social network to have the sponsored content items 206B displayed on the news feed 200.

Various content items 206 include links or selectable menu items 208 with which a member viewing the news feed 200 may interact with content items 206. Selecting a link 208 may cause a related article to be displayed on the member interface 202, may allow the member to comment on, share, “like,” or otherwise interact with the content item 206. Interaction with a link 208 by a member may be registered in the member activity and behavior database 114 as an engagement with the associated content item 206.

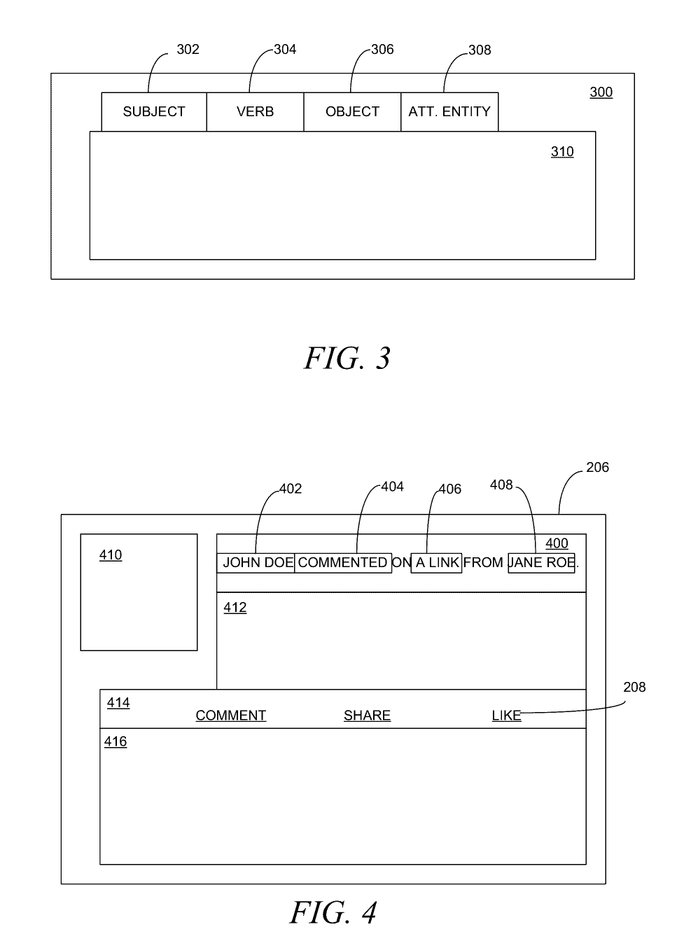

FIG. 3 is an abstract block depiction of a content item record 300 that corresponds to one of the content items 206, in an example embodiment. The content item record 300 includes a subject register 302, a verb register 304, an object register 306, and an attributed entity register 308. The content item record 300 further includes a content field 310 in which content, such as text, an image, an article, a URL, and so forth, is stored. Additional registers and/or fields may be included for additional information, such as a unique alphanumeric identifier of the content item 206, and so forth. The content item record 300 may be stored in a database or otherwise in an electronic data storage device of the social network system 100 and accessed by other components of the system 100.

Each register 302, 304, 306, 308 includes electronic data storage space, or may allow for electronic data storage space, to store a word or phrase related to the associated part of speech. Thus, in an illustrative example, the subject register 302 may store the proper name “John Doe” and the verb register 304 may store the word “commented”, the root word “comment”, or another word related to the same root word. Additionally or alternatively, the verb register may include the verb phrase “commented on” or other similar phrases related to the root word “comment”. In such an example, the object register 306 may store the word “link” or “URL” or other related word or associated phrase, such as “a link”. To continue with the example, the attributed entity register 308 may store the proper name “Jane Roe”.

Custom properties may be defined for verbs and objects. Once defined, can activity can be published with the properties. On output, comments and counts of other social actions can be attached to each activity to facilitate rendering the comments and counts can be render in line with the activities. Similar activities can be grouped into common families according to a selectable data field of the activity. Annotations can allow semantic regions of text to be marked up upon displaying an activity.

Verbs, objects, and other data types disclosed herein can be customized and regularized between and among content item records 300. Thus, “commented” may be an acceptable verb but “remarked on” may not be, and an attempted use of the phrase “remarked on” may be regularized to “commented”, and so forth. Data types can be primitive or complex according to their number of customizable properties. Properties can be utilized to specify data type layout on the screen 300, such as according to syntax and appearance. The develop application 212 can be utilized to customize such properties. The properties can be selectable and customizable according to standard protocols known in the art or according to proprietary protocols.

FIG. 4 is a block diagram of a content item 206 as displayed in a portion of the news feed 200 and as based on an associated content item record 300, in an example embodiment. The content item 206 includes a body 400 of an activity as generated by the summarizer module 214. The illustrative example body 400 includes a subject field 402, a verb field 404, an object field 406, and an attributed entity field 408. The body 400 may be generated based on a content item record 300. The illustrated example is based on the illustrative example presented with respect to the content item record 300 illustrated above.

To form the content item 206, the content item publishing module 106 may populate the fields 402, 4040, 406, 408 according to their respective registers 302, 304, 306, 308 and include linking text as appropriate. Thus, the content item publishing module 106 may recognize that to make a grammatically correct sentence the word “from” should be added between the object field 406 and the attributed entity field 408. It is to be noted and emphasized that the content item publishing module 106 may rearrange the fields 402, 404, 406, 408 as appropriate to generate grammatically correct sentences. Thus, if the subject register 302 were empty and the verb register 304 were “shared” then the sentence in the illustrative example may read “Jane Roe shared a link.”

The body 400 can be organized and presented according to rendering templates. Such templates can be predefined within the content item publishing module 106. In various non-limiting examples, the rendering templates can include: singular actor, past tense verb, object; singular actor, past tense verb, activity; singular actor, past tense verb; two actors, past tense verb, object; two actors, past tense verb, activity; three person actors, past tense verb, object; three non-person actors, past tense verb, object; three person actors, past tense verb, activity; three non-person actors, past tense verb, activity; actor, past tense verb, two objects; actor, past tense verb, three objects; and additional combinations and permutations consistent with the rendering of text.

In various examples, the rendering templates can be utilized in rendering the body 400 in multiple languages. In an example, the rendering templates are in English. Upon the selection and population of the English rendering template with the body fields 402, 404, 406, 408, as appropriate to the rendering template, the body 400 is then translated from English to the desired language. In various examples, an available automated translation program is utilized or the body 400 is manually translated by a human operator.

Alternatively, rendering templates can be created in multiple languages and utilized to create the body 400 in those languages utilizing the body fields 402, 404, 406, 408 as input. In such examples, the templates are stored in multiple languages and the appropriate language template selected for rendering the body 400 in a given language. The body fields 402, 404, 406, 408 can be separately translated as appropriate for inclusion in the rendering template in the particular language. Certain rendering templates may not have a one-to-one relationship between languages due to potential formatting and language-rule variations between languages; a concept that may be applied with a single template in one language may require two or more templates in a second language due to differing grammatical rules.

The content item 206 as illustrated further includes an image field 410, such as a picture of an attributed entity or image related to the object. A content field 412 provides space to display the content of the content item 206, such as a link, text, an image, and the like. The interaction field 414 provides interaction links 208. A social summary field 416 may be included to record social network interactions related to the content item 206, such as by displaying user comments, numbers of “likes” and shares of the content item 206, and so forth.

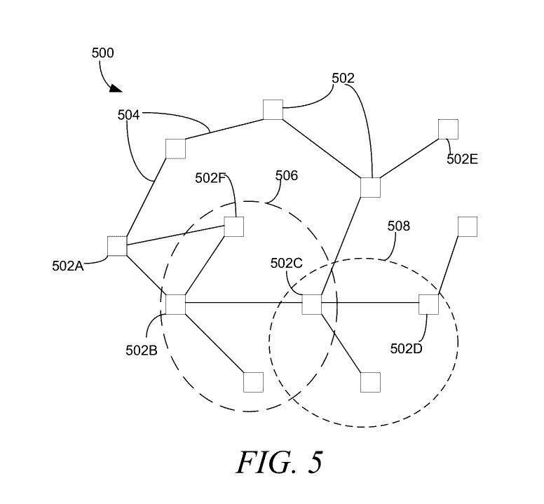

FIG. 5 is a simplified illustration of a social graph 500, in an example embodiment. The social network 500 may be provided by the social network system 100 or any suitable system.

The social network 500 includes m 502 linked to one another within the social network 500 via connections 504. An entity 502 may be a member of the social network 500, a user of the social network 500, a company or organization that has access and may post content to the social network 500, or any person, organization, or system that may interact with or influence the social network 500. Not all entities 502 have connections 504 with all of the other entities 502. Certain entities 502 have further affiliations with other entities 502. For instance, certain entities 502 are employees of the same company 506, as noted in those members' 502 profile data 116. Other entities 502 are related to one another for having attended the same school 508.

Entities 502 of the social network 500 have defined connection relationships between one another. Entities 502A, 502B who have a direct connection 504 have a first-degree connection. Entities 502A, 502C who do not have a direct connection 504 with one another but who each have a direct connection 504 to another entity 502B have a second-degree connection. Entities 502A, 502D who do not have a second-degree connection but who are connected via two other entities 502B, 502C have a third-degree connection, and so forth.

The illustration of the social network 500 is simplified for the purposes of explanation. It is to be understood that the social network 500 may incorporate millions or billions of entities 502. Each of those entities 502 may have dozens or hundreds of affiliations or more that may be formally chosen by each entity 502, such as groups that the entity 502 may elect to join, or may be inferred by the social network 500 from the member's 502 profile data 116.

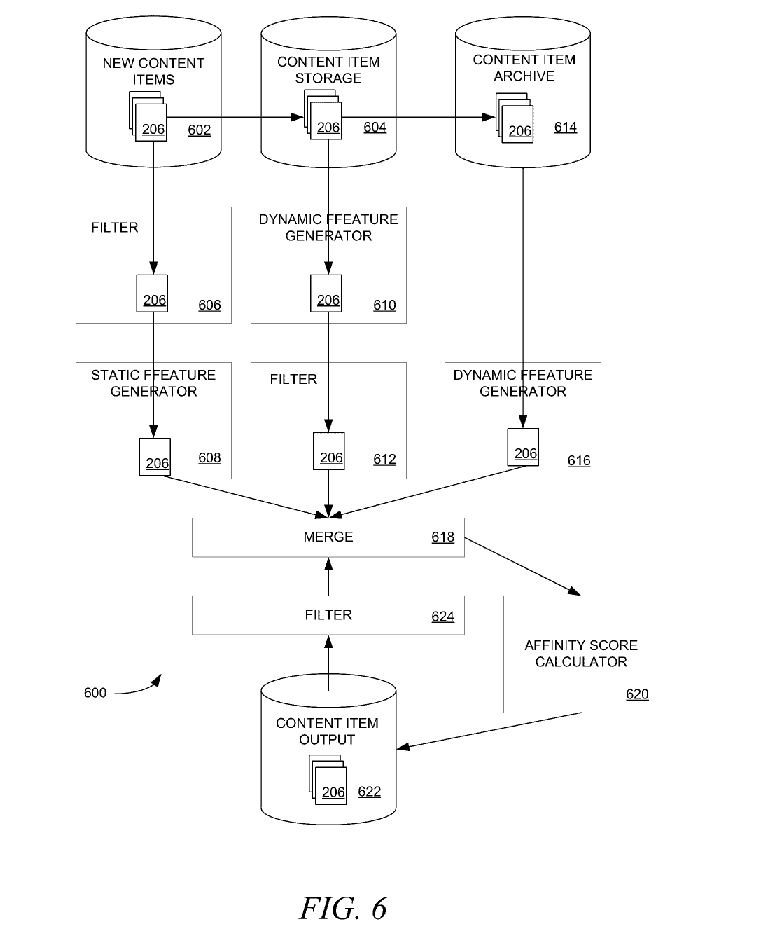

FIG. 6 is a system 600 for proactively identifying content items for a member of a social network, in an example embodiment. In various examples, the system 600 is a subsystem of the social network system 100, with various components included in or accessed by the content item identifier module 108. Alternatively, various components of the system 600 are not necessarily components of the social network system 100 but rather are accessed by the social network system 100.

The system 600 includes a new content items database 602 storing content items 206 that have recently been generated or otherwise have recently been made eligible for display on user interfaces 202 of members 502 of the social network 500 (e.g., a relatively old content item 206 is newly interacted with). In an example, the content items stored in the new content items database 602 have an eligibility timestamp of less than or equal to a threshold time, such as one (1) day. The new content items database 602 periodically transmits the content items 206 stored therein to a content item storage database 604 as well as to a filter 606. The period at which the new content items database 602 transmits content items 206 is less than or equal to the threshold time.

The content item storage database 604 is configured to store content items 206 that have an eligibility timestamp of greater than the threshold time for the new content items database 602 but less than a maximum threshold time, such as fourteen (14) days. Alternatively, the content item storage database 604 does not have a maximum threshold time and instead weights subsequent determined scores to reduce the scores of content items 206 the older the timestamp. In an example, the weight is an exponential decay function. In an example, the determined scores are multiplied by 0.5 for every seven (7) days after the eligibility timestamp. Examples that include weighting of the determined scores may also incorporate a maximum threshold time, such as sixty (60) days. Alternatively, content items 206 may be expunged from the content item storage 604 upon the determined score as weighted falling below a minimum score threshold.

The establishment of the new content items database 602 and the content item storage database 604 provides a mechanism for subjecting differentiating between content items 206 that are sufficiently new to the system 600 and content items 206 that have been relatively well-established in the system 600. It is to be recognized that physical or logical separation or differentiation between such content items 206 may be managed within a single database based on the same requirements that define the two databases 602, 604 above without the need for physical separation of the content items 206. However, it is noted that the separation of the databases 602, 604 may provide for various efficiencies and/or ease of operation.

The content items 206 of the new content items database 602 may be content items 206 for which sufficient time may not necessarily have elapsed to ensure that those content items 206 may be the subject of relatively more rigorous, dynamic assessments of their suitability for display to various members 502 of the social network. In particular, in various examples, the new content items 206 of the new content items database 602 may not be considered for inclusion in a candidate set of content items 206, as disclosed herein. Instead, as will be disclosed herein, such new content items 206 may instead be subjected to various static and conventional assessments without respect to inclusion in a candidate set of content items 206. By contrast, the content items 206 of the content item storage database 604 may be understood to have been available in the network 600 for a sufficient time that the content items 206 may be dynamically assessed for inclusion in a candidate set of content items 206.

The content items 206 that are in the new content items database 602 are processed through a filter 606 and to a static feature generator 608. The filter and the static feature generator 608 may combine to form an online system that may assess content items 206 for suitability for display to a particular member 502 upon that member 502 logging on to the social network. The online system may thus operate on a contingent basis or as needed rather than continuously or on a fixed schedule.

As illustrated, the content items 206 from the new content items database 602 pass through a filter 606 and a static feature generator 608. The filter 606 optionally provides for a separate assessment of the individual content items 206 for desired minimum characteristics of the content items 206 themselves. For instance, a content item 206 may be assessed for characteristics of individual quality, including spelling/grammatical errors, brevity, viruses, scams or suspect origins, and the like. The parameters of the filter 606 may be selected based on the priorities of the social network administrators.

The static feature generator 608 may apply the focused criteria disclosed herein for the rapid identification of content items 206 for display to a member 502 upon the member 502 logging in to the social network. In various examples, the focused criteria are siloed and specific to particular categories of content items 206 or relationships of those content items 206 to the member 502. The focused criteria and particular categories of content items may be accessed or otherwise generated according to methodologies disclosed in U.S. Patent Application Publication No. 2014/0143163, “USER CHARACTERISTICS-BASED SPONSORED JOB POSTINGS” and U.S. Patent Application Publication No. 2014/0143323, “USER CHARACTERISTICS-BASED SPONSORED COMPANY POSTINGS”, which are incorporated herein by reference in their entirety.

The content items from the content item storage database 604 pass through the dynamic feature generator 610 and the filter 612. The content item storage database 604, the dynamic feature generator 610, and the filter 612 combine to form an offline system that operates, at least in part, without necessarily requiring a prompt from an outside source or a member 502 to logon to the social network. As will be disclosed in detail herein, for various members 502, the content items 206 of the content item storage database 604 are organized into candidate sets, with each member 502 having a candidate set oriented to that member and based on that member's social graph 112. The establishment of candidate sets of content items 206 may be by the dynamic feature generator 610 or by the content item identification module 108 prior to the content items 206 being passed to the generator 610. Thus, in various examples, all content items 206 may be passed to the generator 610 or only those content items 206 that are part of candidate sets may be passed to the generator 610.

For each content item 206 of a candidate set, the dynamic feature generator 610 may obtain and utilize profile data 116 and activity data 118 of the member 502 that corresponds to the candidate set. The profile data 116 and activity data 118 may be utilized to identify content items 206 related to topics with which the associated member 502 has shown or may have interest. For instance, topics with which the member 502 has interacted over a predetermined time period according to the activity data 118 may be identified and content items 206 related to those topics may be assessed as having a higher affinity for the member 502 than other content items 206.

The filter 612 may establish similar filter objects to that of the filter 606 but may be directed at and tailored to the results of the dynamic feature generator 610. Thus, in an example, the filter 612 may filter out content items 206 that have relatively low levels of social interaction in the social network generally based on the activity data 118 among multiple member 502. Thus, even if a content item 206 may have been identified as being one for which the member 502 may have an affinity, the content item 206 may still be filtered out if the content item 206 does not have sufficiently high interaction within the social network generally. In an example, a content item 206 that is not in the top half of content items 206 for overall interactions as indicated by the activity data 118 is filtered out by the filter 612.

The system optionally further includes a content item archive 614 configured to store content items 206 that include content items 206 having a timestamp of greater than the threshold for inclusion in the content item storage database 604. The content item archive 614 may, in various examples, provide content items 206 that may be relevant to activities on the social network. For instance, a content item 206 may be related to another content item 206 that is popular or trending on the social network. Or the content item 206 may have be accessed directly, such as via a search or other mechanism. Additionally or alternatively, the content item archive 614 may include all content items 206 on the social network and may be directed in particular to producing content items 206 that are of “viral” interest because of member 502 interaction with the content item 206.

The archive 614 may transmit content items 206 to a dynamic feature generator 616 that incorporates the same or similar dynamic feature considerations as the dynamic feature generator 610. In addition, the dynamic feature generator 616 may consider whether or not a content item 206 has been “viral” over a predetermined time period, such as over a preceding two-day period. The dynamic feature generator 616 may access member activity data 118 to identify interactions with content items 206 from the archive 614. Content items 216 with relatively high levels of interaction may be assessed for other dynamic features, as disclosed herein. A relatively high level of interaction may be reflected in an absolute number of interactions over the predetermined time period, a change in the absolute number of interactions over the predetermined time period, or a relative number of interactions over the predetermined time period relative to, for instance, an average number of interactions with other content items 206 in the archive 614. The thresholds for identifying a content item 206 as being “viral” may be dependent on the circumstances of the standards of the social network and what standards the administrators of the social network may have for a content item 206 to be considered “viral”.

The features generated for each individual content item 206 passes through from the various sources 602, 604, 614 may be merged to form a set of features of each individual content item 206. Thus, for a given content item 206 that has, over time, passed through the static feature generator 608 and the dynamic feature generators 610, 616, the merge module 618 merges those features into a single set of features for that content item 206. As such, a single content item 206 may start in the new content items database 602 and pass through the static feature generator 608 to obtain static features. After that same content item 206 passes over to the content item storage database 604, the content item 206 may pass through the dynamic feature generator 610 to obtain dynamic features. After that same content item 206 passes over o the content item archive 614, that content item 206 may pass though the dynamic feature generator 616 to obtain additional dynamic features. The merge module 618 the merges all of the features obtained for that content item 206 into a single set of features for that content item 206.

It is to be noted and understood that the set of features for a content item 206 may change over time depending on when the content item passes through the various feature generators 608, 610, 616. Thus, if a content item 206 has only passed through the dynamic feature generator 610 then the set of features produced by the merge module 618 will only include dynamic features. However, if, at a later time, the content item 206 passes through the static feature generator 608 then the merge module 618 will merge the static features as generated with the existing set of dynamic features.

Additionally, a content item 206 may be repeatedly subjected to a given feature generator 608, 610, 616. For instance, the social network system 100 may specify that each content item 206 in a candidate set be assessed for dynamic features on a daily basis. As such, the merge module 108 may update the dynamic features of the set of features of a given content item 206 based on any changes in those features over time.

The set of features are passed to an affinity score calculator 620. The affinity score calculator 620 determines an affinity score for each of the content items 206 based on the set of features for that content item 206. Upon the affinity score having been calculated, the content items 206 are passed to a content item output database 622 where they may be provided for display on the news feed 200 in positions according to their respective affinity scores. Content items 206 having higher affinity scores may be placed in higher positions 204 than content items 206 with lower affinity scores. In various examples, the content items 206 are ranked according to their affinity scores and positioned sequentially in positions 204 according to their ranks.

Content items 206 that have been stored in the content item output database 622 may subsequently be filtered in a filter 624 and provided to the merge module 618 for consideration with new content items 206 provided by the various sources 602, 604, 614. The filter 624 may filter out content items 206 that have a timestamp of greater than a predetermined threshold or may attach a weight to the affinity score of content items 206 that cross various thresholds, as disclosed with respect to the filter 606.

It is noted that, as a content item 206 may pass through the static feature generator 608 from the new content items database 602 as well as through the dynamic feature generator 612 from the content item storage database 604, a given content item 206 may have one or more static affinity scores and one or more a dynamic affinity scores. Thus, the affinity score of the content item as a whole accounts for both the static and the dynamic affinity scores, as will be disclosed herein.

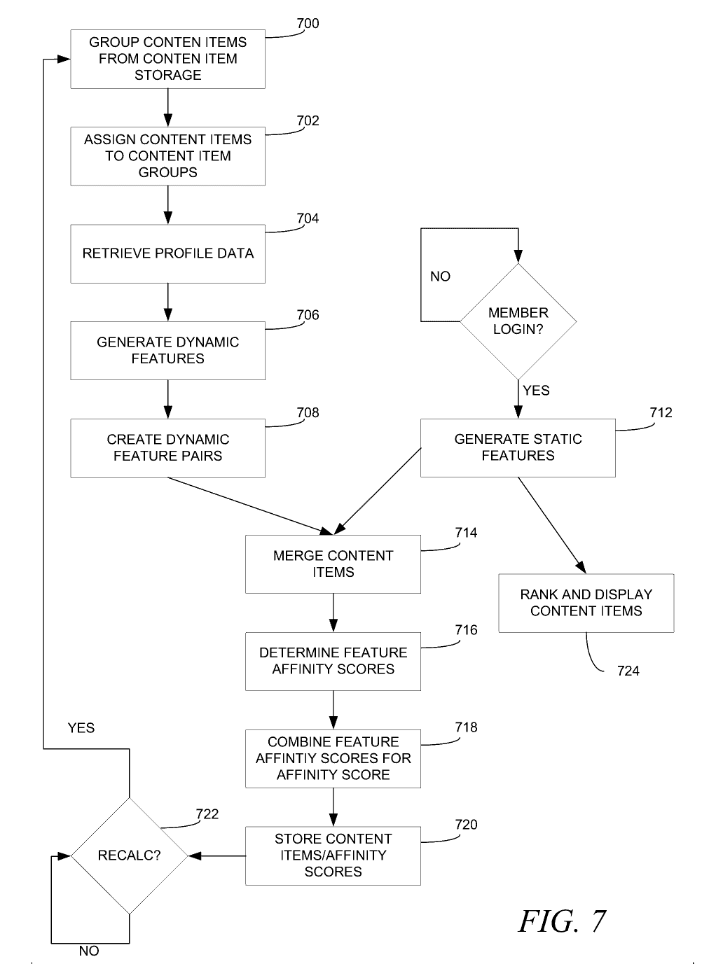

FIG. 7 is a flowchart for proactively identifying content items for a member of a social network, in an example embodiment. The flowchart will be described with respect to the social network system 100 and the system 600, though it is to be understood that the principles disclosed herein may be applied to or implemented by any suitable system. The flowchart incorporates the content item databases 602 and 604 but does not describe the database 614 with particularity. However, it is to be understood and recognized that content items 206 obtained from the content item archive 614 via the dynamic feature generator 616 may be incorporated into the flowchart according to the same principles disclosed in this description of the flowchart and herein generally.

At 700, content items 206 in the content item storage database 604 are grouped according to their respective object identifiers in their respective object fields 406.

At 702, each content item 206 is assigned or not assigned to individual ones of multiple candidate sets of content items 206 based on a union of an actor as stored in the actor field 402 and the member's 502 social graph 112. Each candidate set corresponds to a single member 502 of the social network. Thus, in an example, if the actor of a content item 206 is Company X, then the content item 206 in question is assigned to each candidate group corresponding to a member 502 who has Company X as a connection in their respective social graphs 112, for instance because the member 502 follows Company X. By way of further example, if the actor is member John Doe then the content item 206 is assigned to the candidate set of each member 502 who is connected with John Doe.

The actor is not necessarily an entity 502 of the social graph 500. However, if the actor is any organization with which members 502 may be associated then the content item 206 may be assigned to a candidate set. For instance, members 502 may choose to follow a content channel in the social network in which an entity that is not necessarily part of the social network posts content that is displayed to members 502 who follow that entity. If an entity with a content channel in the social network is the actor of a content item 206, the content item 206 may be assigned to candidate sets of the members 502 who follow the entity on the content channel.

The candidate set is determined without respect to whether or not the associated member 502 has logged into the social network. In various examples, candidate sets are determined automatically and regularly over time. For instance, candidate sets may be determined on a daily basis or based on some other periodic scheduled interval.

At 704, for a candidate set, the profile data 116 for the associated member 502 are retrieved from the profile database 110.

At 706, for each object 406 of each content item 206 in a candidate set, if the object 406 matches a content item identifier then the dynamic feature generator 610 obtains dynamic features for assessment against the content item 206. In various examples, the content item identifier is a serial number or other serial identifier which can uniquely identify content items 206 among the total population of content items 206. Depending on various conditions of the available objects and actors of the content items 206, different features may be accessed and utilized to obtain individual affinity scores that may, as will be disclosed herein, be utilized to obtain a cumulative affinity score.

In an example, some or all of the content items 206 placed into a candidate set may be have some or all of the following content item features generated by the dynamic feature generator 610: number of characters in the content item 206; number of words in the content item 206; number of characters in the title of the content item 206; an industry of an attributed entity; a language of the content item 206; a quality score of the content item 206 as disclosed herein; a number of interactions with the content item 206 by members 502 of the social network; and a subject matter topic of the content item 206 (e.g., music, art, automotive, engineering, etc.). In an example, some or all of the content items 206 placed in a content group may have some or all of the following member features generated by the feature generator 610 or obtained from the profile data 116 of the member 502: age; gender; skills; job title; country or location; career track (e.g., highest title); and industry. It is noted and emphasized that these lists are illustrative and not exhaustive and that any of a variety of features in addition to those listed here may be utilized.

At 708, for each content item 206 of the candidate set of the member 502, the dynamic feature generator 610 generates feature pairs including some or all of the member-related features paired with some or all of the content item-related features to create multiple unique feature pairs, each with one member feature and one content item feature. Thus, in an example, each individual content item feature may be paired with each individual member feature to create feature pairs. In such an example, the number of characters content item feature may be paired with the age of the member 502 to create a first pair, the gender of the member 502 to create a second pair, the skills of the member 502 to create a third pair, and so forth. In an example, certain content item features may not be paired with certain member features if no statistical relationship is determinable between those features.

At 710, the new content items database 602 determines if the member 502 has logged in. If not, the new content items database 602 continues to wait If the member 502 has logged in, the new content items database 602 transmits content items 206 to the static features generator 608. It is noted that the content items 206 sent to the static features generator 608 are not necessarily the same content items 206 as are included in the candidate set of content items 206. On the contrary, in various circumstances, there may be little to no overlap between the content items 206 of the candidate set and those that are sent to the static features generator 608.

At 712, the static features generator 608 generates static features for the content items 206. The static features generator 608 utilizes the mechanisms disclosed herein for generating the static features, such as jobs the member 502 may be interested in and so forth.

At 714, the features or feature pairs content items 206 that have been assessed by the static feature generator 608 and the dynamic feature generator 610 are merged by the merge module 618. Additionally, as will be disclosed herein, the merge module 618 may further incorporate content items 206 from content item output database 622.

At 716, for each content item 206 having features or feature pairs that have been merged by the merge module 618, the affinity score calculator 620 determines a feature affinity score for each feature or feature pair of that content item 206.

Thus, the number of characters in the content item may receive a 1.0 if it is greater than a certain threshold and less than another threshold, and may be less than 1.0 by varying amounts depending on how far outside of the thresholds the number of characters of the content item 206 is; in such an example, a content item 206 may desirably have a number of characters within a specified range, and it may reduce the value of the content item if the content item 206 has too many or too few characters. The thresholds may be the same for all members 502 or may be determined for each member individually based on their past interactions in the activity data 118 with other content items 206 and the number of characters in those content items 206. Thus, for instance, the thresholds may be optimized based on the tendency of a given member 502 to interact with content items 206 having particular numbers of characters. These principles may be applied as well to the other features that are based on an objective fact.

The above example, however, utilizes only the content item feature without respect to profile data features of the member 502 to whom the candidate set is related. In various examples, feature affinity scores are based on a relationship between the content item feature and profile data features.

By way of illustrative example, it is determined empirically that a number of characters in a content item 206 has a logarithmic relationship to a likelihood of any given member 502 to interact with the content item 206. Thus, the aspect of the feature affinity score related to the content item feature number of characters would, in an example, be log (# of characters+1). It may further be empirically determined that, relative to a baseline, members 502 who have a profile data age feature from twenty-one (21) to thirty (30) years should have a number of characters feature weighted by 0.7. Thus, in the illustrative example, the feature affinity score for a number of characters feature of a content item 206 equaling one thousand (1,000) as a function of the age feature for a first member 502 being twenty-five (25) years old is 0.7*log (1000+1)=2.100.

It is noted that, while the exemplary number of characters feature of the content item 206 may be fixed for that content item 206, the age feature may change from member 502 to member 502. Thus, the weight for a member from age thirty-one (31) to forty (40) years may be 0.77, resulting in a feature affinity score of 2.310 for the same content item 206 for a thirty-five (35) year old person.

The number of characters feature may be assessed against any or all profile data features of the member 502. Thus, it may be determined that the weight for a member who has a job title feature of “software engineer” in relation to the number of characters content item feature is 0.59. Thus, in the above example, the feature affinity score between number of characters and job title would be 0.59*log(1000+1)=1.770. Profile data features that have no discernable relationship to a given content item feature may have a weight of zero, resulting on that feature affinity score being zero as well.

In this way, some or all of the available content item features may be paired with and assessed against some or all of the available profile data features to generate an individual feature affinity score for each of the dynamic feature pairs. Thus, a feature affinity score may be determined for the feature pair (number of words and age); a feature affinity score may be determined for (number of words and gender); a feature affinity score may be determined for (number of words and skills); a feature affinity score may be determined for (number of words and job title); and so forth. The dynamic affinity score may thus be the combination, such as the sum, of each individual feature affinity score between the various feature pairs.

The affinity score calculator 620 further determines or otherwise produces a static affinity score based on the relevance scores produced by the various static feature sources. The affinity score calculator 620 may utilize a relevance score directly or may weight the relevance score so as to produce a static affinity score that tends to relate in a desired way to typical dynamic affinity scores. Thus, for instance, if a Jobs module produces content items 206 with relevance scores in the range of 0.0 to 1.0, the affinity score calculator 620 may weight those scores by a factor of ten (10) to produce a static feature affinity score. In various examples, if only one static feature affinity score is provided for a content item then the static feature affinity score may be the static affinity score for the content item 206. If a content item 206 has more than one static feature affinity score, the static feature affinity scores may be combined, such as by being added, to generate the static affinity score.

At 718, individual feature scores are combined by the affinity score calculator to create one or both of a static affinity score for the content item 206 and a dynamic affinity score for the content item 206. As described herein, individual feature affinity scores may be summed or otherwise combined to generate the static and/or dynamic affinity scores. The static and dynamic affinity scores are then combined to create the affinity score for the content item 206. The calculation of the affinity score is performed for each of the content items 206 provided by the merge module 618.

At 720, either the content items 206 themselves or, in various examples, the affinity scores of the content items 206 are stored in the content item output database 622. If the affinity scores are stored, then the content item identification module 108 may access the related content items 206 as needed to populate the user interface 202 as needed form whatever database the content item 206 happens to be stored in.

At 722, the content item identification module 108 determines if dynamic features and/or dynamic feature affinity scores may be recalculated based, for instance, on the passage of time. In an example, every twenty-four (24) hours the content item identification module 108 returns to operation 700 to generate a new candidate set and proceed with determining dynamic affinity scores, according to the flow chart. However, in subsequent iterations of the flowchart, the merge operation at 714 incorporates content items 206 and/or affinity scores and features that have already been stored in the content item output database 622 by way of the filter 624.

The content item identification module 108 may operate with an interrupt based on the member 502 associated with the candidate set logging in to the social network. Upon the member 502 logging in, the operations related to the static affinity score may be run for the content items, such as by starting at operation 710 as disclosed herein. Further, upon the member 502 logging in, the content item identification module 108 proceeds from operation 718 to operation 724.

At 724, the content item identification module 108 ranks the content items 206 according to their affinity scores and outputs some or all of the content items 206 or the affinity scores as stored in the content item output module 622 to the content item publishing module 106 for display on the user interface 202. In various examples, the content publishing module 106 causes the content items 206 to be displayed in positions 204 according to their affinity scores. In an example, a content item 206 with the highest affinity score is placed in the first position 204(1), a content item 206 with the second highest affinity score is placed in the second position 204(2), and so forth. In various examples, the content publishing module 106 incorporates more factors in assigning positions 204 than only the affinity scores. For instance, the ordering of content items 206 in positions may be changed based on requirements for the placement of sponsored content items and/or other priorities of the social network. However, the affinity scores may nevertheless provide a basis for the positioning of content items 206 in the user interface 202 regardless of whether or not additional considerations are applied.

### Flowchart

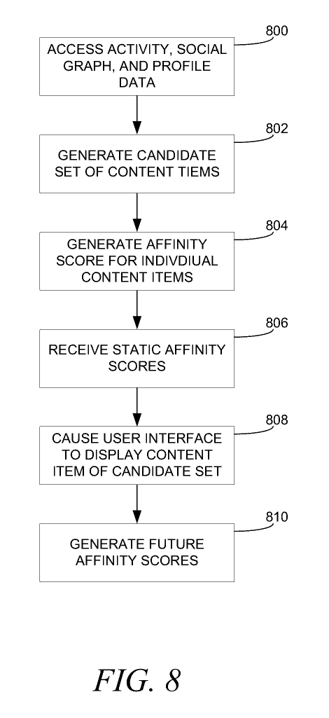

FIG. 8 is a flowchart for proactively identifying content items for a member of a social network, in an example embodiment. The flowchart may be implemented with any device or system disclosed herein or any suitable device or system.

At 800, a processor accesses activity data from an activity database, social graph data of a first member of a social network from a social graph database, and profile data of the first member from a profile database, the activity data including indications of interactions by second members of the social network with content items of the social network.

At 802, for the first member, the processor generates a candidate set of content items including content items with which the second members interacted based on a social graph relationship between the second members and the first member.

At 804, the processor generates an affinity score for each individual one of the content items of the candidate set based on a plurality of profile data features of the first member in relation to a plurality of features of the individual content item. In an example, generating the candidate set and generating the affinity score occur when the first member is not logged in to the social network.

At 806, in an example, the affinity score is a dynamic affinity score, and upon the first member logging in to the social network, the processor receives individual static affinity scores for a plurality of content items, at least one of the plurality of content items not being in the candidate set.

At 808, upon the first member logging in to the social network, the processor causes, via a network interface, a user interface to display to the first member a content item of the candidate set based on the affinity score of the content item. In an example, causing the user interface to display the content item of the candidate set further includes causing the display of a plurality of content items according to their respective dynamic affinity scores and static affinity scores. In an example, a content items of the plurality of content items includes a dynamic affinity score and a static affinity score and wherein causing the user interface to display the one of the plurality of content items is based on a combination of the dynamic affinity score and the static affinity score of the one of the plurality of content items. In an example, the static affinity scores are based on a relationship of an associated on of the plurality of content items with a profile data feature of the first member. In an example, the social graph relationship is based on at least one of a social graph connection between the first member and an associated one of the second members and the first member following the associated one of the second members in the social network.

At 810, the processor generates feature affinity scores for each of a plurality of pairs of features, each pair of features including one profile data feature and one feature of the individual content item, wherein the affinity score is based on a combination of the feature affinity scores.

### System

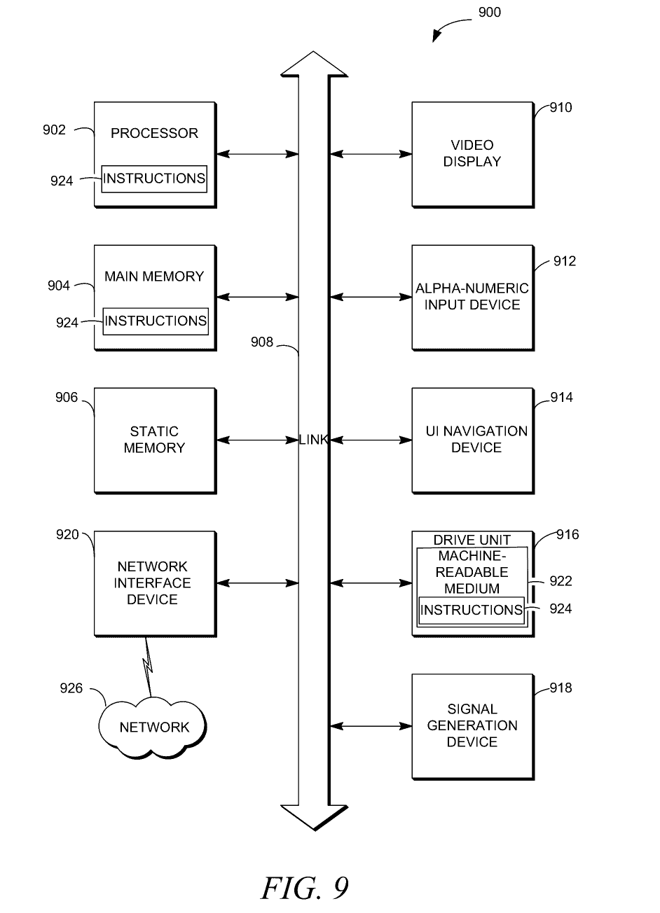

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system and within which instructions 924 (e.g., software) for causing the machine 900 to perform any one or more of the methodologies discussed herein may be executed. In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The machine 900 may further include a graphics display 910 (e.g., a plasma display panel (PDP), a light emitting diode (LED) display, a liquid crystal display (LCD), a projector, or a cathode ray tube (CRT)). The machine 900 may also include an alphanumeric input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media. The instructions 924 may be transmitted or received over a network 926 via the network interface device 920.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 900), such that the instructions, when executed by one or more processors of the machine (e.g., processor 902), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
accessing, by a processor, activity data from an activity database, social graph data of a first member of a social network from a social graph database, and profile data of the first member from a profile database, the activity data including indications of interactions by second members of the social network with content items of the social network;
generating, with the processor, for the first member, a candidate set of content items including content items with which the second members interacted based on a social graph relationship between the second members and the first member;
generating, with the processor, an affinity score for each individual one of the content items of the candidate set based on a plurality of profile data features of the first member in relation to a plurality of features of the individual content item; and
upon the first member logging in to the social network, causing, with the processor, via a network interface, a user interface to display to the first member a content item of the candidate set based on the affinity score of the content item.

2. The method of claim 1, wherein generating the candidate set and generating the affinity score occur when the first member is not logged in to the social network.

3. The method of claim 1, wherein the affinity score is a dynamic affinity score and further comprising:
upon the first member logging in to the social network, receiving individual static affinity scores for a plurality of content items, at least one of the plurality of content items not being in the candidate set;
wherein causing the user interface to display the content item of the candidate set further includes causing the display of a plurality of content items according to their respective dynamic affinity scores and static affinity scores.

4. The method of claim 3, wherein a content items of the plurality of content items includes a dynamic affinity score and a static affinity score and wherein causing the user interface to display the one of the plurality of content items is based on a combination of the dynamic affinity score and the static affinity score of the one of the plurality of content items.

5. The method of claim 3, wherein the static affinity scores are based on a relationship of an associated on of the plurality of content items with a profile data feature of the first member.

6. The method of claim 1, wherein the social graph relationship is based on at least one of a social graph connection between the first member and an associated one of the second members and the first member following the associated one of the second members in the social network.

7. The method of claim 1, further comprising generating feature affinity scores for each of a plurality of pairs of features, each pair of features including one profile data feature and one feature of the individual content item, wherein the affinity score is based on a combination of the feature affinity scores.

8. A computer readable medium comprising instructions which, when implemented by a process, cause the processor to perform operations comprising:
access activity data from an activity database, social graph data of a first member of a social network from a social graph database, and profile data of the first member from a profile database, the activity data including indications of interactions by second members of the social network with content items of the social network;
generate, for the first member, a candidate set of content items including content items with which the second members interacted based on a social graph relationship between the second members and the first member;
generate an affinity score for each individual one of the content items of the candidate set based on a plurality of profile data features of the first member in relation to a plurality of features of the individual content item; and
upon the first member logging in to the social network, cause, via a network interface, a user interface to display to the first member a content item of the candidate set based on the affinity score of the content item.

9. The computer readable medium of claim 8, wherein generating the candidate set and generating the affinity score occur when the first member is not logged in to the social network.

10. The computer readable medium of claim 8, wherein the affinity score is a dynamic affinity score and further comprising instructions which cause the processor to:
upon the first member logging in to the social network, receive individual static affinity scores for a plurality of content items, at least one of the plurality of content items not being in the candidate set;
wherein causing the user interface to display the content item of the candidate set further includes causing the display of a plurality of content items according to their respective dynamic affinity scores and static affinity scores.

11. The computer readable medium of claim 10, wherein a content items of the plurality of content items includes a dynamic affinity score and a static affinity score and wherein causing the user interface to display the one of the plurality of content items is based on a combination of the dynamic affinity score and the static affinity score of the one of the plurality of content items.

12. The computer readable medium of claim 10, wherein the static affinity scores are based on a relationship of an associated on of the plurality of content items with a profile data feature of the first member.

13. The computer readable medium of claim 8, wherein the social graph relationship is based on at least one of a social graph connection between the first member and an associated one of the second members and the first member following the associated one of the second members in the social network.

14. The computer readable medium of claim 8, further comprising generating feature affinity scores for each of a plurality of pairs of features, each pair of features including one profile data feature and one feature of the individual content item, wherein the affinity score is based on a combination of the feature affinity scores.

15. A system, comprising:
a computer readable medium comprising instructions which, when implemented by a process, cause the processor to perform operations comprising:
access activity data from an activity database, social graph data of a first member of a social network from a social graph database, and profile data of the first member from a profile database, the activity data including indications of interactions by second members of the social network with content items of the social network;
generate, for the first member, a candidate set of content items including content items with which the second members interacted based on a social graph relationship between the second members and the first member;
generate an affinity score for each individual one of the content items of the candidate set based on a plurality of profile data features of the first member in relation to a plurality of features of the individual content item; and
upon the first member logging in to the social network, cause, via a network interface, a user interface to display to the first member a content item of the candidate set based on the affinity score of the content item.

16. The system of claim 15, wherein generating the candidate set and generating the affinity score occur when the first member is not logged in to the social network.

17. The system of claim 15, wherein the affinity score is a dynamic affinity score and further comprising instructions which cause the processor to:
upon the first member logging in to the social network, receive individual static affinity scores for a plurality of content items, at least one of the plurality of content items not being in the candidate set;
wherein causing the user interface to display the content item of the candidate set further includes causing the display of a plurality of content items according to their respective dynamic affinity scores and static affinity scores.

18. The system of claim 17, wherein a content items of the plurality of content items includes a dynamic affinity score and a static affinity score and wherein causing the user interface to display the one of the plurality of content items is based on a combination of the dynamic affinity score and the static affinity score of the one of the plurality of content items.

19. The system of claim 17, wherein the static affinity scores are based on a relationship of an associated on of the plurality of content items with a profile data feature of the first member.

20. The system of claim 15, further comprising the processor and the network interface.
